(19) United States
(12) Patent Application Publication
(10) Pub. No.: US 2017/0283751 A1
(43) Pub. Date: Oct. 5, 2017

(54) APPARATUS FOR PRODUCING WORT

(71) Applicant: Youn Hwan LIM, Incheon (KR)

(72) Inventor: Youn Hwan LIM, Incheon (KR)

(21) Appl. No.: 15/440,777

(22) Filed: Feb. 23, 2017

(30) Foreign Application Priority Data
Mar. 31, 2016 (KR) 10-2016-0039162

(51) Int. Cl. C12C 7/00

(52) U.S. Cl. CPC C12C 7/00

(57) ABSTRACT

An apparatus for producing a wort includes an outer cylindrical container a lower plate received therein; an inner cylindrical container received in the outer cylindrical container such that a wort circulation space is defined the outer cylindrical container and the inner cylindrical container, wherein a malt screener is received in the inner container above the bottom of the inner cylindrical container to be spaced from the bottom of the inner cylindrical container, wherein the side wall of the inner cylindrical container has a plurality of side holes defined therein, and a wort space is defined between the lower plate and the malt screener in the inner cylindrical container; a wort circulator fluid-communicating with the wort circulation space and the wort space to enable circulation of the wort between the wort circulation space and the wort space; and a heater disposed in the wort circulation space to heat the wort therein.

### CROSS-REFERENCE TO RELATED APPLICATION

This application claims the benefit of Korean patent application No. 10-2016-0039162 filed on Mar. 31, 2016, the entire content of which is incorporated herein by reference for all purposes as if fully set forth herein.

### BACKGROUND

### Field of the Present Disclosure

The present disclosure relates to an apparatus for producing a wort, and, more particularly, to an apparatus for producing a wort wherein an inner cylindrical container is received in an outer cylindrical container to define a wort circulation space therebetween to allow continuous circulation of the wort to promote saccharification of malt.

### Discussion of Related Art

The production of beer in breweries includes mashing malts with water whereby the “extract” is brought into solution, and in separating the melt solution (first wort) from the malt residues (spent grains), whereupon the solution is boiled with addition of the required amount of hops. The hot wort is then passed over a filter to separate the hops and subsequently cooled. The wort is then fermented with yeast and after the fermentation is completed, the beer is transferred to storage for aging.

The mashing process uses germinated cereal malt such as barley malt and wheat malt to produce wort. This process is a process for leaching the soluble component of malt which is a raw material and solubilizing the insoluble component by the enzyme of malt to obtain nutrients necessary for growth of yeast and fermentation by yeast. The mashing process comprises malt grinding, saccharification, wort filtration, but the wort boiling process is additionally performed to control the sugar content.

Conventionally, wort is produced by grinding malt, which is a raw material of beer, into a reaction vessel having a predetermined size, together with water having a predetermined temperature, and stirring the mixture at 55° C.˜75° C.

The reaction vessel is provided with a stirring shaft and a stirring blade at the center of a container having a predetermined size and a stirring motor connected to the stirring shaft is installed on the upper side of the vessel or a lid coupled to the vessel. The stirring wing is rotated by the shaft to stir the malt and the water in the container so that the wort is produced.

However, the wort production apparatus as described above has a stirring motor, a stirring shaft, and a stirring wing in a reaction vessel, and is complicated in its structure, has high weight and large size, and can be applied to a method of producing a wort in a large amount. However, it has been difficult to apply it to a small amount of handmade beer by individuals due to problems such as facility size, economic cost, and inconvenience.

In the case of producing a small amount of handmade beer, malt and water are put into a reaction vessel having a warming property or a reaction vessel capable of heating to a temperature, and then the malt and water are stirred by a manual operation of the operator while maintaining a predetermined temperature, thereby to produce the wort.

However, such manual production of wort may not be done in a single reaction vessel because the mashing process that dissolves the sugar from the malt, the lautering to obtain a clean wort, and the sparging to collect the remaining sugar from the malt may not be executed in the single reaction vessel. Thus, it takes a lot of time to manufacture the wort, and there is a problem that a work space of a predetermined size must be ensured due to an increase in parts for each operation.

Especially, in the mashing process, temperature control is a very important part. However, since the conventional method is difficult to control the temperature, if it is not an expert, the quality of the wort itself deteriorates.

The prior arts are as follows: patent document 1: Korean patent No. 10-1549062 (2015.08.26); patent document 2: Korean patent application publication No. 10-2004-0042772 (2004.05.20); patent document 3: Korean patent No. 10-0998672 (2010.11.30); and patent document 4 Korean patent application publication No. 10-2002-0070938 (2002.09.11)

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide an apparatus for producing a wort wherein heated wort wraps an inner cylindrical container filled with malt and the wort circulates between the inner and outer cylindrical containers, thereby to improve the wort production rate.

In one aspect of the present disclosure, there is provided an apparatus for producing a wort, the apparatus comprising: an outer cylindrical container having an open top, a side wall, and a lower plate received therein and fixed to the side wall; an inner cylindrical container having a side wall, an open top and a bottom, wherein the inner cylindrical container is received in the outer cylindrical container such that a wort circulation space is defined between the side wall of the outer cylindrical container and the side wall of the inner cylindrical container, wherein the bottom of the inner cylindrical container is blocked by the lower plate of the outer cylindrical container, and a malt screener is received in the inner container above the bottom of the inner cylindrical container to be spaced from the bottom of the inner cylindrical container, wherein the side wall of the inner cylindrical container has a plurality of side holes defined therein, and a wort space is defined between the lower plate and the malt screener in the inner cylindrical container; a wort circulator fluid-communicating with the wort circulation space and the wort space to enable circulation of the wort between the wort circulation space and the wort space; and a heater disposed in the wort circulation space to heat the wort therein.

In one implementation, the wort circulator includes: a first tube communicating with the wort space; a second tube communicating with the first tube and the wort circulation space; a circulation pump disposed between the first tube and the second tube; and a wort injection nozzle communicating with the second tube and present in the wort circulation space to allow circular direction injection of the wort in the wort circulation space.

In one implementation, a seal is formed between a bottom end of the side wall of the inner cylindrical container and the lower plate received in the outer container.

In one implementation, the side holes are defined in and substantially across an entire length of the side wall of the inner cylindrical container.

In one implementation, the side holes are defined in an upper-most portion of the side wall of the inner cylindrical container.

In one implementation, the apparatus further comprises a further inner cylindrical container removably received in the inner cylindrical container, wherein the further inner cylindrical container is sized such that the further inner cylindrical container tightly contacts the inner cylindrical container when the further inner cylindrical container is received in the inner cylindrical container.

The apparatus for producing a wort in accordance with the present disclosure is configured such that the inner cylindrical container filled with the malt is positioned within the wort maintaining a predetermined saccharification temperature, so that the temperature of the malt is kept constant. Thus, the warming effect on my malt is generated, and this warming effect not only hastens the saccharification, but also the saccharification efficiency is improved.

The unidirectional and circular directional wort flow in the wort circulation space realized by the wort injection nozzle may cause a vortex wort flow in the wort circulation space. This vortex wort flow may generate a force applied to the inner cylindrical container. Thus, the press-down of the inner cylindrical container may press-down the seal formed on the bottom end of the side wall of the inner container against the lower plate of the outer cylindrical container. In this way, the cylindrical inner container may be stably seated on and in the outer cylindrical container without separate securing means.

In the present invention, a heater is provided in a wort circulation space formed between the outer cylindrical container and the inner cylindrical container to prevent damage to the malt due to the heating of the heater. The clearer wort is produced by the prevention of damage. That is, when the heater is located beneath the malt, the barley grain located below the malt is burned due to the heating of the heater. However, the apparatus for producing a wort in accordance with the present disclosure is configured such that the heater is installed in the wort circulation space so that the wort is circulating at the saccharification temperature without damaging the malt.

As the water or wort is repeatedly circulated around the malt by the wort circulator during the saccharification or mashing process, saccharification without heat loss is achieved. Further, the lautering is continued and the clearer wort can be obtained.

The apparatus for producing a wort in accordance with the present disclosure allows the malt to be filled only in the inner cylindrical container, and the inner cylindrical container to be separated from the outer cylindrical container to facilitate further cleaning.

Since the wort produced by the continuous circulation method of water or wort, there is no need for a separate stirring device to stir the malt, so that the miniaturization is possible. Further, this can be applied to the production of handmade beer.

In accordance with the present disclosure, the saccharification or mashing, lautering, and sparging operations all are executed in a present single apparatus. This saves sparging and lautering times, which allows the production time of wort and beer to be shortened.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is an exploded view of an apparatus for producing a wort in accordance with one embodiment of the present disclosure.

FIG. 2 is an exploded view of an apparatus for producing a wort in accordance with another embodiment of the present disclosure.

FIG. 3 is a bottom view of an apparatus for producing a wort in accordance with one embodiment of the present disclosure.

FIG. 4 is an example top view for illustrating a flow state of a wort within a circulation space in accordance with one embodiment of the present disclosure.

FIG. 5 is an example side elevation view for illustrating a flow state of a wort within an inner cylindrical container in accordance with one embodiment of the present disclosure.

FIG. 6 is an example side elevation view for illustrating a flow state of a wort within an inner cylindrical container in accordance with another embodiment of the present disclosure.

FIG. 7 is an example side elevation view for illustrating a flow state of a wort within an inner cylindrical container in accordance with still another embodiment of the present disclosure.

FIG. 8 is an example side elevation view for illustrating a sparging operation in accordance with one embodiment of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

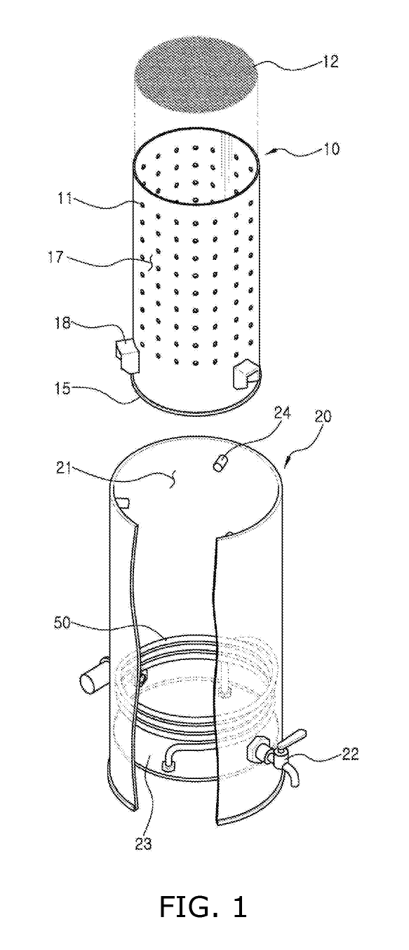

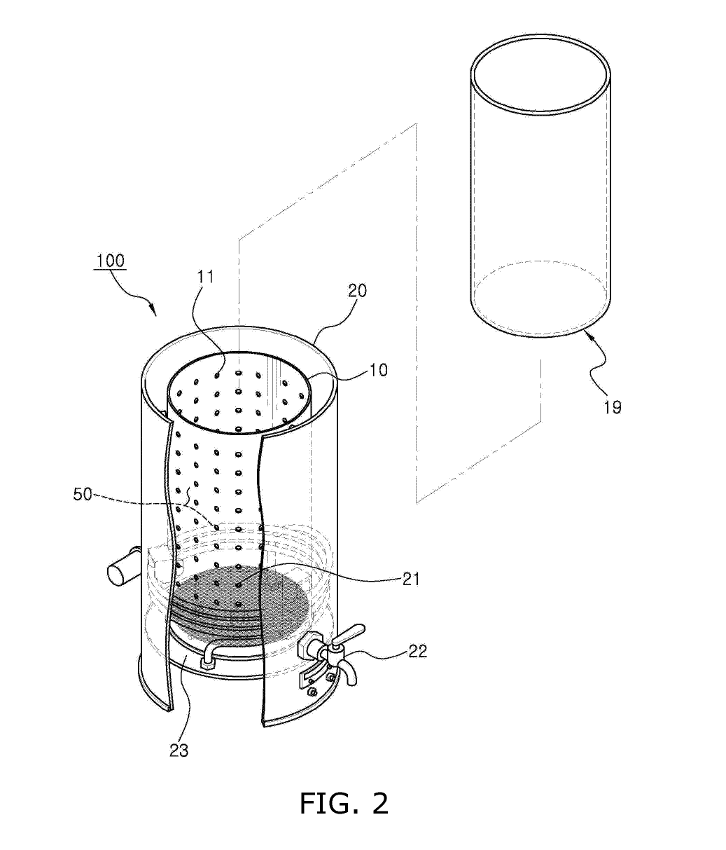

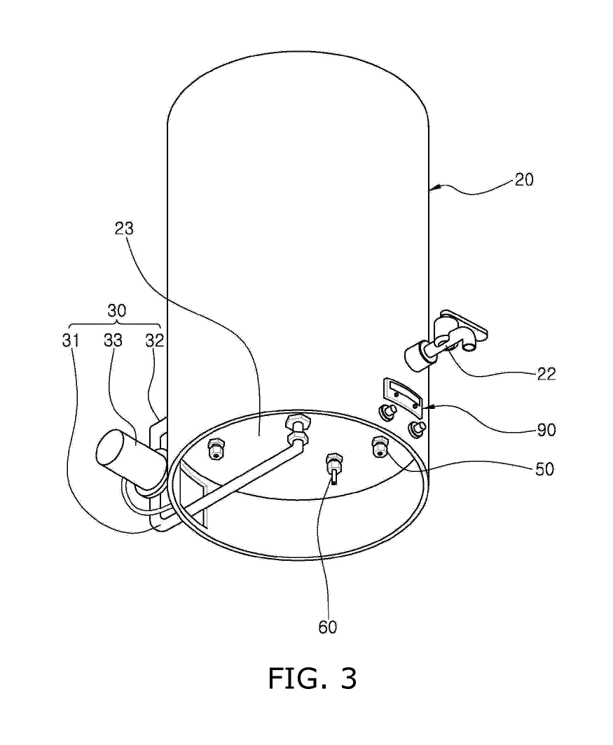

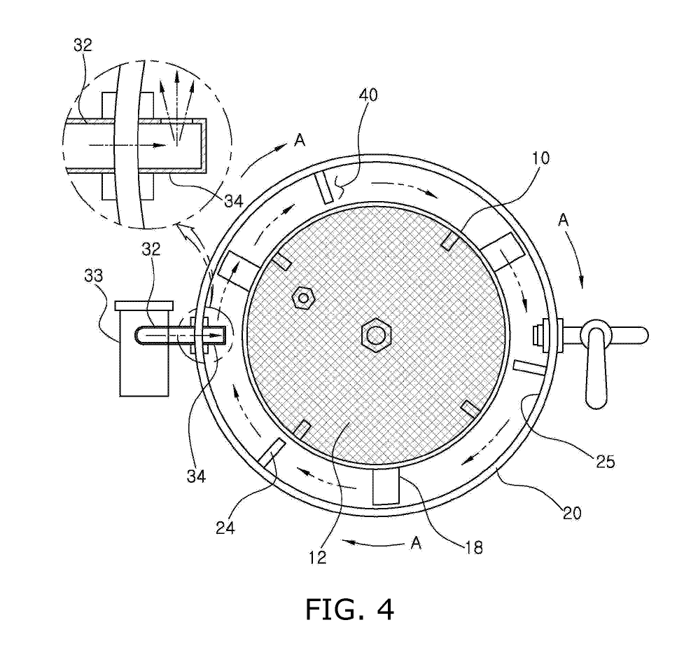

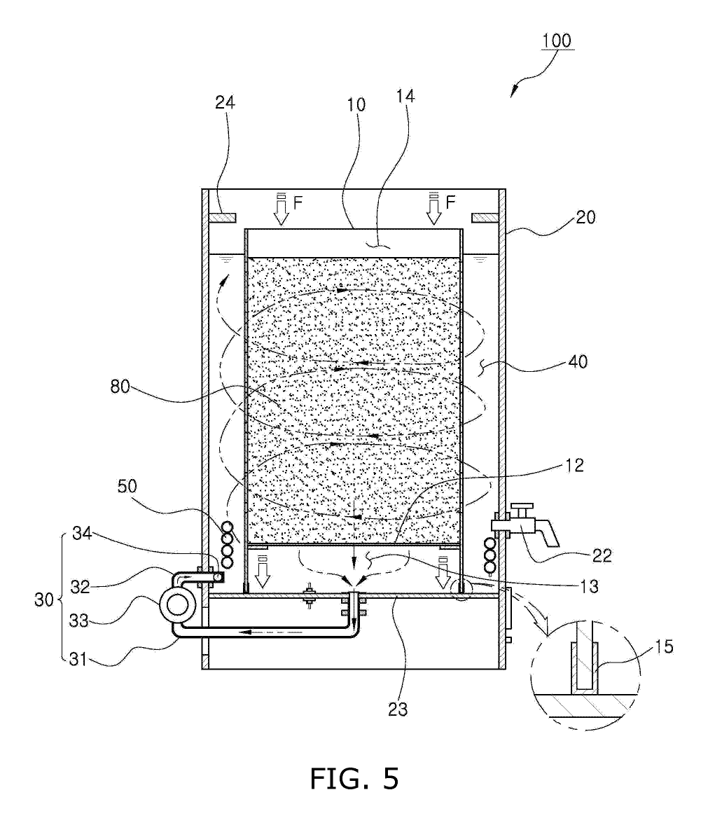

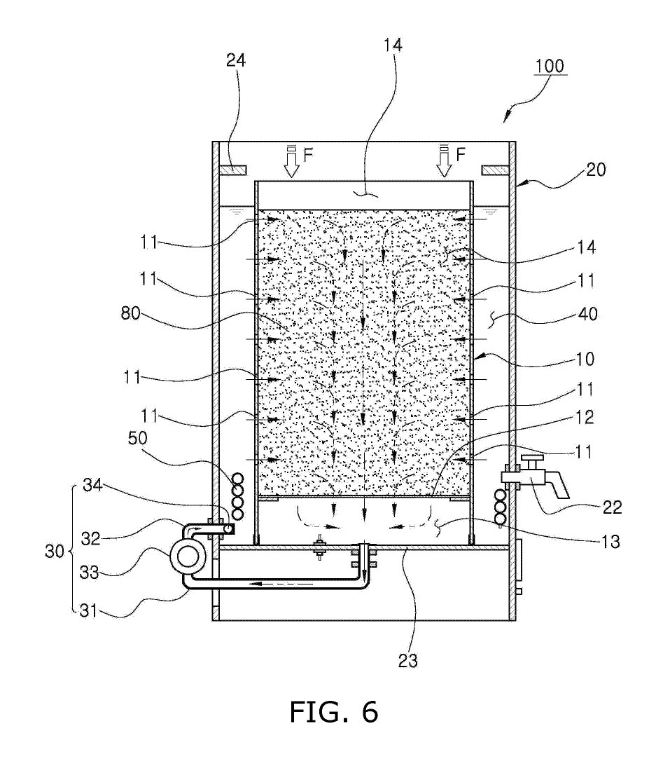

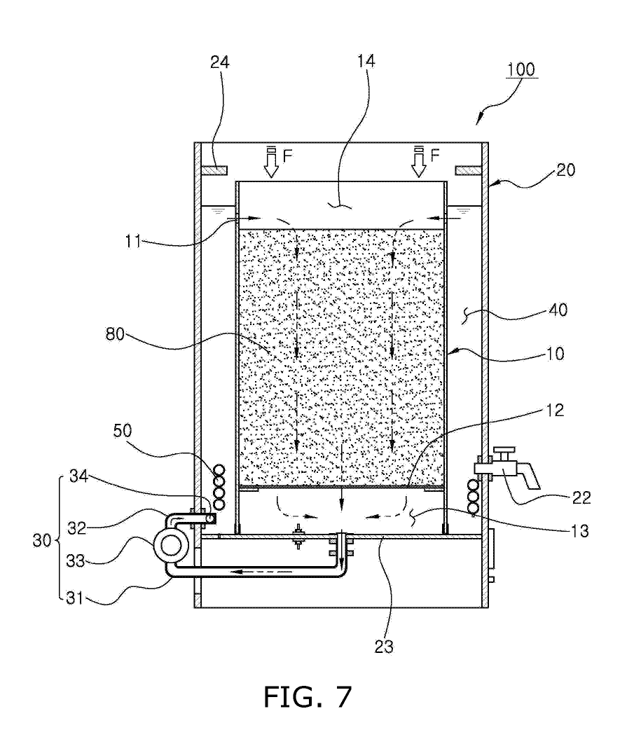

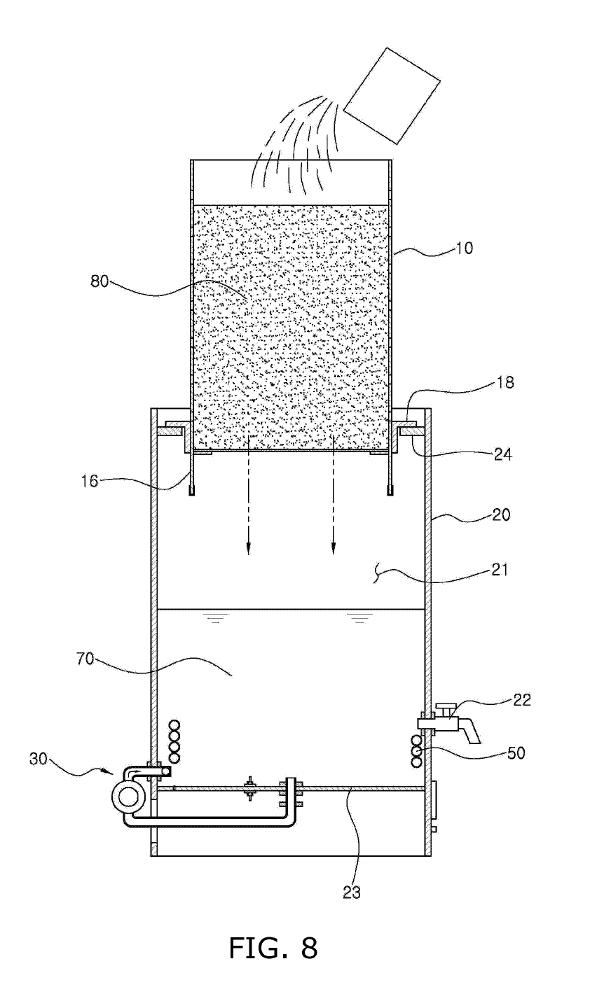

FIG. 1 is an exploded view of an apparatus for producing a wort in accordance with one embodiment of the present disclosure. FIG. 2 is an exploded view of an apparatus for producing a wort in accordance with another embodiment of the present disclosure. FIG. 3 is a bottom view of an apparatus for producing a wort in accordance with one embodiment of the present disclosure. FIG. 4 is an example top view for illustrating a flow state of a wort within a circulation space in accordance with one embodiment of the present disclosure. FIG. 5 is an example side elevation view for illustrating a flow state of a wort within an inner cylindrical container in accordance with one embodiment of the present disclosure. FIG. 6 is an example side elevation view for illustrating a flow state of a wort within an inner cylindrical container in accordance with another embodiment of the present disclosure. FIG. 7 is an example side elevation view for illustrating a flow state of a wort within an inner cylindrical container in accordance with still another embodiment of the present disclosure. FIG. 8 is an example side elevation view for illustrating a sparging operation in accordance with one embodiment of the present disclosure.

The apparatus for producing a wort in accordance with one embodiment of the present disclosure may include an outer cylindrical container 20 having an open top, a side wall, and a lower plate 23; an inner cylindrical container 10 having a side wall and an open top and a bottom, wherein the inner cylindrical container 10 is received in the outer cylindrical container 20 such that a wort circulation space 40 is defined between the side wall of the outer cylindrical container 20 and the side wall of the inner cylindrical container 10, the bottom of the inner cylindrical container 10 is blocked by the lower plate of the outer cylindrical container 20, and a malt screener 12 is disposed above the bottom of the inner cylindrical container to be spaced from the the bottom of the inner cylindrical container, wherein the side wall of the inner cylindrical container has a plurality of side holes 11 defined therein, and a wort space 13 is defined between the lower plate 23 and the malt screener 12 in the inner cylindrical container 10; a wort circulator 30 fluid-communicating with the wort circulation space 40 and the wort space 13 to enable circulation of the wort between the wort circulation space 40 and the wort space 13; and a heater 50 disposed in the wort circulation space 40 to heat the wort.

Regarding an operation of the apparatus for producing a wort in accordance with one embodiment of the present disclosure, the wort 70 may pass through the malt 80 contained in the inner cylindrical container 10 into the wort space 30 and then may be circulated via the wort circulator 30 into the wort circulation space 40 in which the wort may circulate in a circular flow A, and the wort may be heated by the heater 50 and, then, the heated wort may be fed through the plurality of side holes 11 into the inner cylindrical container 10 to the malt 80 therein.

The outer cylindrical container 20 may have the open top and be sized to receive the inner cylindrical container 10 and may have an inner space 21 defined therein. The inner space 21 may communicate with a wort outlet valve 22 disposed above the lower plate 13. The wort outlet valve 22 may fluid-communicate with the into the wort circulation space 40.

The inner cylindrical container 10 may have the malt screener 12 coupled to the side wall thereof to screen the malt. A seal 15 may be formed between an outer edge of the lower plate 23 and the inner face of the side wall of the outer cylindrical container to prevent a leakage of the wort.

The malt screener 12 may allow the passage of the water or wort but disallow the passage of the malt 80. Thus, the malt screener 12 may be disposed in the inner cylindrical container 10 to divide the inner space in the inner cylindrical container 10 into an upper malt space 14 and the lower wort space 13.

The malt screener 12 may not be limited particularly in terms of a material thereof. For example, the malt screener 12 may be embodied as a metal mesh. The malt screener 12 may be secured to the side wall of the inner cylindrical container 10 via a welding. Alternatively, the malt screener 12 may be seated on an annular horizontal support 16 to extending inwardly from the inner face of the side wall of the inner cylindrical container 10. Further, at least one malt screener 12 may be defined in the inner cylindrical container.

Moreover, the inner cylindrical container 10 may have the plurality of side holes 11 defined in the side wall thereof, such that the the malt space 14 may fluid-communicate with the wort circulation space 40. Thus, the wort may be fed from the wort circulation space 40 through the side holes 11 into the malt space 14 and then to the malt 80 therein.

Moreover, the side holes 11 may be configured such that a wort is fed to top and side faces of the malt space 14. Thus, the side holes 11 may be defined in and across an entire length of the side wall of the inner cylindrical container such that the malt space in the inner cylindrical container communicates with the wort circulation space across the entire length. Thus, the wort may be fed to top and side faces of the malt space 14 and to the malt 80 in the malt space in the inner cylindrical container. Then, the malt 80 in the malt space in the inner cylindrical container may be floated on the wort 70 and thus, the contact area between the malt 80 and the wort 70 may increase. Then, the wort may pass through the malt 80 to the wort space 13. Then, the wort in the wort space 13 may be circulated via the wort circulator 30 to the wort circulation space 40. Again, the wort may be fed from the space 40 to top and side faces of the malt space 14 and to the malt 80 in the malt space in the inner cylindrical container. Then, the malt 80 in the malt space in the inner cylindrical container may be floated on the wort 70 and thus, the contact area between the malt 80 and the wort 70 may increase. In this way, a saccharification in the malt may be promoted. Thus, the sugar production rate may be enhanced and the circulation of the wort may be rapid.

Alternatively, as shown in FIG. 7, the side holes 11 may be configured such that a wort is fed only to a top face of the malt space 14. Thus, the side holes 11 may be defined only in a most-upper portion of the side wall of the inner cylindrical container such that the malt space in the inner cylindrical container communicates with the wort circulation space at the most-upper portion thereof. Thus, the wort may be fed to top and side faces of the malt space 14 and to the malt 80 in the malt space in the inner cylindrical container. Then, the wort may pass through the malt 80 to the wort space 13. Then, the wort in the wort space 13 may be circulated via the wort circulator 30 to the wort circulation space 40. Again, the wort is fed to the top face of the malt space 14 via the side holes 11 defined in the inner cylindrical container at the the most-upper portion thereof. This wort circulation may lead to the saccharification in the malt.

The inner cylindrical container 10 may be received in the outer cylindrical container such that the seal 15 may be formed between the bottom end of the side wall of the inner cylindrical container 10 and the lower plate 23 received in the outer cylindrical container. The inner cylindrical container 10 may be received into the inner space 21 in the outer cylindrical container and may be supported on the lower plate 23. When the inner cylindrical container 10 is received in the outer cylindrical container 20, the inner space of the inner cylindrical container may be divided into an upper space above the malt screener 12 and a lower space below the malt screener 12. The upper space may act as the malt space 14, while the lower space may act as the wort space 13 defined between the malt screener 12 and the lower plate 23 fixed to the side wall of the the outer cylindrical container 20.

Moreover, the present apparatus may include a temperature sensor 60 to measure the temperature of the wort entering the wort space 13. The temperature sensor 60 may be installed on the lower plate of the outer cylindrical container 20 as shown in FIG. 3.

Alternatively, in one embodiment, as shown in FIG. 2. a further inner cylindrical container 19 may be received in the inner cylindrical container 10 such that the further inner cylindrical container 19 tightly contacts the inner cylindrical container 10. Thus, the malt may be prevented from moving through the side holes in the inner cylindrical container [symbol] side holes 11 to the wort circulation space.

When the malt 80 fills the inner cylindrical container 10 and the water fills the the inner cylindrical container 10 and the water is stirred, the malt may move through the side holes 11 of the inner cylindrical container to the wort circulation space. To suppress this, the further inner cylindrical container 19 may be inserted into the inner cylindrical container 10, and the malt 80 fills the further inner cylindrical container 19 and the water fills the the further inner cylindrical container 19 and the water is stirred, the malt may not move through the side holes 11 of the inner cylindrical container to the wort circulation space 40 because the side holes 11 of the inner cylindrical container is blocked by the further inner cylindrical container 19 tightly contacting the inner cylindrical container. Moreover, during the saccharification process, the further inner cylindrical container 19 may be removed from the inner cylindrical container 10. During the saccharification process, the wort circulation by the wort circulator including a circulator pump may prevent the malt from moving from the inner cylindrical container 10 through the side holes 11 to the the wort circulation space 40.

When the outer cylindrical container 20 receives the inner cylindrical container 10, the wort circulation space 40 may be defined between the inner side face of the outer cylindrical container 20 and the outer side face of the inner cylindrical container 10.

The wort space 13 may defined between the lower plate 23 and the malt screener 12 in the inner cylindrical container 10. However, when the inner cylindrical container 10 is removed from the outer cylindrical container 20, the wort space 13 and wort circulation space 40 may be combined to the inner space 21. The wort 70 circulating between the wort space 13 and wort circulation space 40 may be stored in the inner space 21.

The heater 50 may keep the saccharification temperature and apply the heating energy to the wort in the wort circulation space 40. The heater 50 may be installed in the wort circulation space 40 and may be secured to the outer cylindrical container 20.

When the outer cylindrical container receives the inner cylindrical container 10 to form the wort circulation space 40 therebetween, the heater 50 may extend along the wort circulation space 40 in a circular manner in the wort circulation space 40. The wort circulation space 40 may have an annular shape when viewed from a top.

In order to allow rapid saccharification of the malt, the wort circulator 30 may be configured to realize repeated circulations of the wort 70 between the wort space 13 and wort circulation space 40 and malt space 14. To this end, the wort circulator 30 may include a first tube 31 communicating with the wort space 13, a second tube 32 communicating with the first tube 31 and the wort circulation space 40, a circulation pump 33 disposed between the first tube 31 and the second tube 32, and a wort injection nozzle 34 communicating with the second tube 32 and present in the wort circulation space 40 to allow circular direction injection of the wort 70. The first tube 31 may extend below the lower plate 23 of the outer cylindrical container and may be coupled to the lower plate. The second tube 32 may be coupled to the outer cylindrical container 20.

Regarding the operation of the wort circulator 30, the activation of the circulation pump 33 may enable the wort to move from the wort space 13 via the first tube 31 to the second tube 32, and, then, to the wort circulation space 40. In this connection, the wort may be injected from the wort injection nozzle 34 coupled to the second tube 32 into the wort circulation space 40 such that the wort may flow in the wort circulation space 40 in a circular direction A along an inner face 25 of the outer cylindrical container or along an outer face 17 of the inner cylindrical container. In this connection, as shown in FIG. 4 and FIG. 5, the wort flow in the wort circulation space 40 in a circular direction A may be uni-directional.

This uni-directional and circular directional wort flow in the wort circulation space 40 realized by the wort injection nozzle 34 may enable the inner cylindrical container 10 to be stably seated on and in the outer cylindrical container 20 without separate securing means. Further, a separation between the wort space 13 and wort circulation space 40 may allow reliable circulation of the wort.

Specifically, the uni-directional and circular directional wort flow in the wort circulation space 40 realized by the wort injection nozzle 34 may cause a vortex wort flow in the wort circulation space 40. This vortex wort flow may generate a force F applied to the inner cylindrical container 10 as shown in FIG. 5. Thus, the inner cylindrical container 10 may be pressed-down in the inner space 21 defined in the outer cylindrical container 20. The press-down of the inner cylindrical container may press-down the seal 15 formed on the bottom end of the side wall of the inner container against the lower plate 23 of the outer cylindrical container. In this way, the cylindrical inner container 10 may be stably seated on and in the outer cylindrical container 20 without separate securing means. Further, the press-down of the seal 15 against the lower plate 23 may realize secure separation between the wort space 13 and wort circulation space 40, thereby to allow reliable circulation of the wort. Further, the temperature adjustment in the wort circulation space 40 may be reliably realized.

The wort circulator 30 and heater 50 may be controlled by a controller 90. The controller 90 may be disposed beneath the lower plate 23 of the outer cylindrical container. The present disclosure is not limited thereto. The controller 90 may be integrated with the outer cylindrical container 20. The controller 90 may control the wort circulator 30 and heater 50 in a manual or automatic manner.

Moreover, a plurality of first ribs 24 may extend from the outer cylindrical container 20 on the inner face thereof and in a most-upper portion of the side wall thereof. A plurality of second ribs 18 may extend from the inner cylindrical container 10 on the outer face thereof and in a most-lower portion of the side wall thereof. A plurality of second ribs 18 may extend into the wort circulation space 40. In this connection, the first ribs 24 may be sized to be spaced from the inner cylindrical container 10, while the second ribs 18 may may be sized to be spaced from the outer cylindrical container.

As shown in FIG. 8, during a sparging operation to collect remaining sugars in the malt 80, the first ribs 24 of the outer cylindrical container may support the second ribs 18 of the inner cylindrical container such that the inner cylindrical container 10 is supported on the outer cylindrical container 20 while the inner cylindrical container 10 is substantially out of the outer cylindrical container 20. In this way, using the apparatus for producing a wort in accordance with the present disclosure, including the cylindrical container 20 and inner cylindrical container 10 defined above, the mashing, lautering and, sparging operations all may be executed.

During the use of the apparatus for producing a wort in accordance with the present disclosure, while the inner cylindrical container 10 may be inserted into the outer cylindrical container 20 to define the wort circulation space 40 therebetween, the water may fill the inner cylindrical container 10 and outer cylindrical container 20.

In this connection, the water may have the given temperature. Alternatively, a hot water may be fed to the containers and then a cold water may be fed to the containers to adjust the temperature of the water. The temperature of the water 40 may be adjusted by the heater 50 in the wort circulation space.

Then, the malt may be fed to the malt space 14 in the inner cylindrical container. In this connection, the malt 80 and water in the malt space 14 may be stirred. The malt screener 12 may prevent the malt in the malt space 14 in the inner cylindrical container 10 from passing therethrough. The water may pass through the screener 12 into the wort space 13.

After the malt space 14 has been filled with the malt 80, the saccharification temperature may be kept by the heater 50. Meanwhile, the water or wort may circulate between the wort space 13, wort circulation space 40 and malt space 14 via activation of the wort circulator 30, to be strict, the pump.

During the water passes through the malt 80 repeatedly, the saccharification or mashing may be executed to create a wort. The wort may move to the wort circulator 30 and then to the wort circulation space 40, and then through the side holes 11 of the inner cylindrical container to the malt 80 in the malt space 14. The circulation of the wort may accelerate the saccharification of the malt to product the wort.

Upon the production of the wort, the inner cylindrical container 10 may be raised upwards from the outer cylindrical container 20, and, then, the second ribs 18 may be rested on the first ribs 24 of the outer cylindrical container. The malt residual may remain in the malt space 14 in the inner cylindrical container, and clear wort may remain in the inner space 21 in the outer cylindrical container. Then, the clear wort may be discharged out of the inner space 21 via the wort outlet valve 22.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. An apparatus for producing a wort, the apparatus comprising:
an outer cylindrical container having an open top, a side wall, and a lower plate received therein and fixed to the side wall;
an inner cylindrical container having a side wall, an open top and a bottom, wherein the inner cylindrical container is received in the outer cylindrical container such that a wort circulation space is defined between the side wall of the outer cylindrical container and the side wall of the inner cylindrical container, wherein the bottom of the inner cylindrical container is blocked by the lower plate of the outer cylindrical container, and a malt screener is received in the inner container above the bottom of the inner cylindrical container to be spaced from the bottom of the inner cylindrical container, wherein the side wall of the inner cylindrical container has a plurality of side holes defined therein, and a wort space is defined between the lower plate and the malt screener in the inner cylindrical container;
a wort circulator fluid-communicating with the wort circulation space and the wort space to enable circulation of the wort between the wort circulation space and the wort space; and
a heater disposed in the wort circulation space to heat the wort therein.

2. The apparatus of claim 1, wherein the wort circulator includes:
a first tube communicating with the wort space;
a second tube communicating with the first tube and the wort circulation space;
a circulation pump disposed between the first tube and the second tube; and
a wort injection nozzle communicating with the second tube and present in the wort circulation space to allow circular direction injection of the wort in the wort circulation space.

3. The apparatus of claim 1, wherein a seal is formed between a bottom end of the side wall of the inner cylindrical container and the lower plate received in the outer container.

4. The apparatus of claim 2, wherein a seal is formed between a bottom end of the side wall of the inner cylindrical container and the lower plate received in the outer container.

5. The apparatus of claim 1, wherein the side holes are defined in and substantially across an entire length of the side wall of the inner cylindrical container.

6. The apparatus of claim 2, wherein the side holes are defined in and substantially across an entire length of the side wall of the inner cylindrical container.

7. The apparatus of claim 1, wherein the side holes are defined in an upper-most portion of the side wall of the inner cylindrical container.

8. The apparatus of claim 2, wherein the side holes are defined in an upper-most portion of the side wall of the inner cylindrical container.

9. The apparatus of claim 1, further comprising a further inner cylindrical container removably received in the inner cylindrical container, wherein the further inner cylindrical container is sized such that the further inner cylindrical container tightly contacts the inner cylindrical container when the further inner cylindrical container is received in the inner cylindrical container.

10. The apparatus of claim 2, further comprising a further inner cylindrical container removably received in the inner cylindrical container, wherein the further inner cylindrical container is sized such that the further inner cylindrical container tightly contacts the inner cylindrical container when the further inner cylindrical container is received in the inner cylindrical container.
